(19) United States
(12) Patent Application Publication
(10) Pub. No.: US 2003/0033921 A1
(43) Pub. Date: Feb. 20, 2003

(54) Extension side plate structure of circular sawing machine

(76) Inventor: Chin Chin Chang, Feng-Yuan City (TW)

Correspondence Address: CONNOLLY BOVE LODGE & HUTZ, LLP, 1220 N MARKET STREET, P O BOX 2207, WILMINGTON, DE, 19899

(21) Appl. No.: 09/978,467

(22) Filed: Oct. 17, 2001

(30) Foreign Application Priority Data
Aug. 15, 2001 (TW) 90214172

(51) Int. Cl. B27B 5/20

(52) U.S. Cl. 83/471.3; 83/477.1

(57) ABSTRACT

The present invention is related to an extension side plate structure including two extension side plates symmetrically mounted on two sides of a frame seat of a circular sawing machine respectively. The extension side plate has a top face flush with the top face of the frame seat, and has a first side formed with a positioning groove, and a second side formed with a guide groove. A catch plates is slidably mounted on the extension side plate, and has a first side provided with a positioning threaded rod that is rotatably locked and positioned in the positioning groove of the extension side plate, and a second side provided with a guide rod that is slidably inserted into the guide groove of the rectangular extension side plate, so that the two catch plates may slide on the two extension side plates respectively.

### BACKGROUND OF THE INVENTION

1. Field of the Invention

The present invention relates to an extension side plate structure of a circular sawing machine, and more particularly to an extension side plate structure of a circular sawing machine which may be used to catch and cut workpieces of different sizes and lengths stably and rigidly, thereby enhancing the efficiency of the circular sawing machine for cutting the workpiece.

2. Description of the Related Art

The closest prior art of which the applicant is aware is disclosed in the applicant's Taiwanese Patent Publication No. 276575, which discloses an upper guard cover rotatably mounted on a circular sawing machine. The upper guard cover has a torsion spring so that the upper guard cover may be rotated upward to return to its original position. A catch plate is mounted on the frame seat of the circular sawing machine for catching the workpiece. However, the catch plate is simply available for horizontally catching a workpiece with a smaller size and length, and cannot be used to catch a workpiece with a larger size and length stably and rigidly, thereby greatly decreasing the efficiency of the circular sawing machine for cutting the workpiece.

### SUMMARY OF THE INVENTION

The primary objective of the present invention is to provide an extension side plate structure of a circular sawing machine which may be used to catch and cut workpieces of different sizes and lengths stably and rigidly, thereby enhancing the efficiency of the circular sawing machine for cutting the workpiece.

In accordance with the present invention, there is provided an extension side plate structure of a circular sawing machine, comprising:

two extension side plates respectively screwed on two sides of a frame seat of a circular sawing machine, each of the two extension side plates having a top face flush with a top face of the frame seat of the circular sawing machine, each of the two extension side plates having a first side formed with a positioning groove, and a second side formed with a guide groove, two catch plates each slidably mounted on the top face of each of the two extension side plates, and each having a first side provided with a positioning threaded rod that is rotatably locked and positioned in the positioning groove of the first side of the rectangular extension side plate, and a second side provided with a guide rod that is slidably inserted into the guide groove of the second side of the rectangular extension side plate, so that the two catch plates may slide on the two extension side plates respectively.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of an extension side plate structure of a circular sawing machine in accordance with the preferred embodiment of the present invention;

FIG. 2 is a cross-sectional view of the extension side plate structure of a circular sawing machine taken along line 2-2 as shown in FIG. 1;

FIG. 3 is a schematic operational view of the extension side plate structure of a circular sawing machine as shown in FIG. 2; and

FIG. 4 is a top plan assembly view of the extension side plate structure of a circular sawing as shown in FIG. 1.

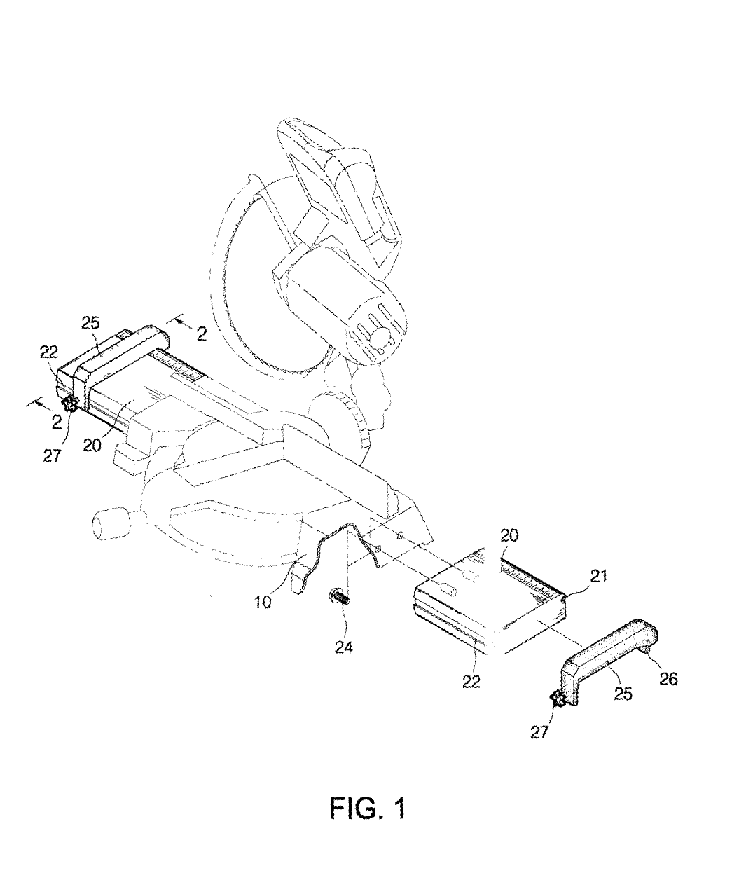

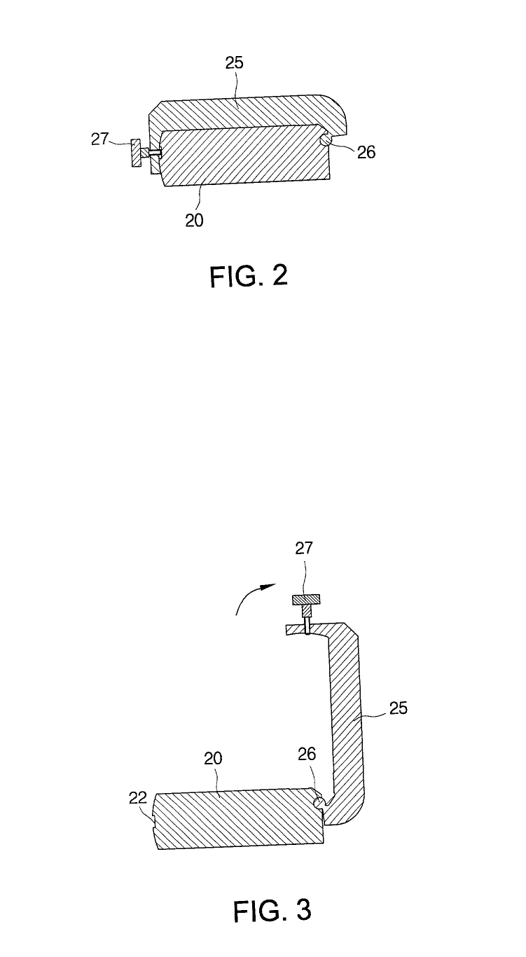

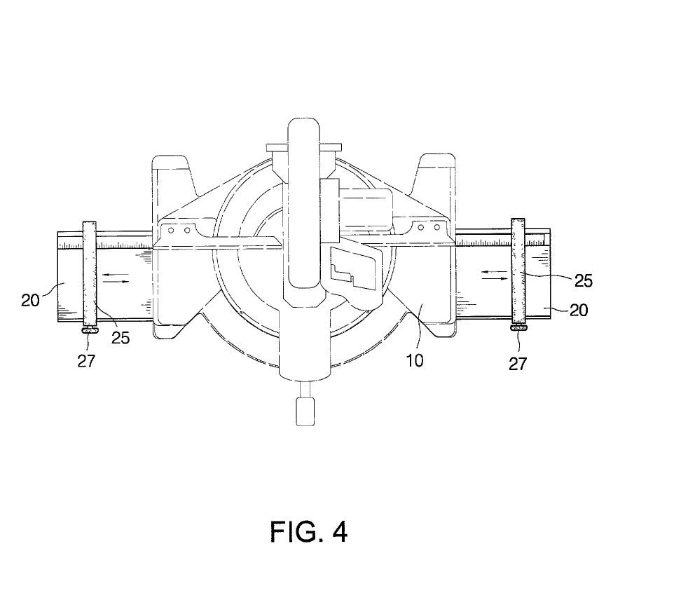

### DETAILED DESCRIPTION OF THE INVENTION

Referring to the drawings, an extension side plate structure of a circular sawing machine in accordance with a preferred embodiment of the present invention comprises two substantially rectangular extension side plates 20 respectively screwed on two sides of a frame seat 10 of a circular sawing machine. Each of the two rectangular extension side plates 20 has a top face flush with a top face of the frame seat 10, so that the extension side plate structure of the present invention may horizontally extend and adjust a width of a work table of the frame seat 10, and may be used to support workpieces of different sizes and lengths that are to be cut.

The two substantially rectangular extension side plates 20 are respectively screwed and assembled on the two sides of the frame seat 10 of the circular sawing machine by multiple bolts 24. Each of the two rectangular extension side plates 20 has a first side formed with a positioning groove 22, and a second side formed with a guide groove 21.

A substantially inverted U-shaped catch plate 25 is slidably mounted on the top face of each of the two rectangular extension side plates 20, and has a first side provided with a positioning threaded rod 27 that is rotatably locked and positioned in the positioning groove 22 of the first side of the rectangular extension side plate 20, and a second side provided with a guide rod 26 that is slidably inserted into the guide groove 21 of the second side of the rectangular extension side plate 20. Thus, the two catch plates 25 at the two sides may slide on the two rectangular extension side plates 20 respectively, so as to adjust the position of each of the two catch plates 25, so that the two catch plates 25 may be used to catch workpieces of different sizes and lengths that are to be cut, thereby enhancing the efficiency of cutting the workpiece.

In summary, the structural features and the embodying effects of the present invention are briefly described as follows.

Each of the two sides of the frame seat 10 of the circular sawing machine is respectively provided with an extension side plate 20 which has a top face horizontally flush with the top face of the frame seat 10, so that the width of the work table of the frame seat 10 of the circular sawing machine of the present invention may be efficiently extended and adjusted so as to support and cut the workpiece having a larger size and length. A catch plate 25 is slidably mounted on the top face of each of the two extension side plates 20. Each of the two catch plates 25 may be adjustably locked and positioned the respective extension side plate 20, so that the two catch plates 25 may be used to catch the workpiece at the two sides in a vertical manner, thereby enhancing the efficiency of the circular sawing machine for cutting the workpiece.

In conclusion, the present invention is to provide an extension side plate structure of a circular sawing machine, wherein each of the two sides of the frame seat 10 of the circular sawing machine is respectively provided with an extension side plate 20, and an upright catch plate 25 is slidably mounted on the top face of the extension side plate 20. Thus, by adjusting relative positions of the two catch plates, the two catch plates of the extension side plate structure may be used to catch workpieces of different sizes and lengths stably and rigidly, so that the circular sawing machine may be used to cut workpieces of different sizes and lengths stably and rigidly.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. An extension side plate structure of a circular sawing machine, comprising:
two extension side plates respectively screwed on two sides of a frame seat of a circular sawing machine, each of the two extension side plates having a top face flush with a top face of the frame seat of the circular sawing machine, each of the two extension side plates having a first side formed with a positioning groove, and a second side formed with a guide groove, two catch plates each slidably mounted on the top face of each of the two extension side plates, and each having a first side provided with a positioning threaded rod that is rotatably locked and positioned in the positioning groove of the first side of the extension side plate, and a second side provided with a guide rod that is slidably inserted into the guide groove of the second side of the extension side plate, so that the two catch plates may slide on the two extension side plates respectively.

2. The extension side plate structure of a circular sawing machine in accordance with claim 1, wherein each of the two extension side plates has a substantially rectangular shape.

3. The extension side plate structure of a circular sawing machine in accordance with claim 1, wherein each of the two catch plates is substantially inverted U-shaped.
